(19) United States
(12) Patent Application Publication
(10) Pub. No.: US 2025/0370805 A1
(43) Pub. Date: Dec. 4, 2025

(54) RAPID DEVELOPMENT PAGE SOLUTION

(71) Applicant: Schlumberger Technology Corporation, Sugar Land, TX (US)

(72) Inventors: Eugene Von Niederhausern, Houston, TX (US); Carl Irving, Houston, TX (US); Thomas Van Zanen, Houston, TX (US); Chinmoy Mohanty, Houston, TX (US); Shreyas Mehta, Houston, TX (US); Bo Zhang, Houston, TX (US); Ralf Werner Holy, Houston, TX (US)

(21) Appl. No.: 18/679,712

(22) Filed: May 31, 2024

(51) Int. Cl. G06F 9/50

(52) U.S. Cl. CPC G06F 9/5027

(57) ABSTRACT

Apparatuses, systems, and methods can include a processing resource and a memory device storing instructions executable by the processing resource. The instructions can include hosting a plurality of domains and registering a plurality of components and/or microservices from the plurality of domains. In addition, the instructions can include locating a plurality of components and/or microservices from the plurality of domains, access one or more components and/or microservices from one or more domains, combining the one or more components and/or microservices on a page to create a personalized page, and deploy the personalized page. In some examples, a user deploys and operates the personalized page.

### BACKGROUND

A platform can be used to provide software solution to data management. Data can be hosted on a cloud system which provides access and delivery to a user, application, or devices. The data can be accessed and delivered to any device connected to the network or cloud system, allowing multiple users, applications, and devices access to the data.

### SUMMARY

An apparatus includes a processing resource and a memory device storing instructions executable by the processing resources. The processing resources is configured to host a plurality of domains, locate a plurality of components and/or microservices from the plurality of domains. The processing resources is also configured to access one or more components and/or microservices of the plurality of components and/or microservices from one or more domain of the plurality of domain and combine the one or more components and/or microservices on a page of a plurality of pages to create a personalized page. The processing resources is also configured to deploy the personalized page. A user deploys and operates the personalized page.

The plurality of components and/or microservices are software components and/or microservices that are accessed from different domains. The plurality of pages are preset with initial components and/or microservices. The initial components and/or microservices are removable from the plurality of pages.

In another embodiment, the system includes one or more processing resources and a memory system including one or more non-transitory, computer-readable storage medium storing instructions. The instructions, when executed by at least one of the one or more processing resources cause the system to perform operations. The operations include registering a plurality of components and/or microservices from a plurality of domains and storing a registry data on a central repository. Registering the plurality of components and/or microservices maps the plurality of components and/or microservices to the same origin using the central repository. The operations also include locating the plurality of components and/or microservices from the plurality of domains using the registry data and accessing one or more components and/or microservices of the plurality of components and/or microservices from one or more domains of the plurality of domains. The operations also include combining the one or more components and/or microservices on a personalized page and deploying the personalized page. A user deploys and operates the personalized page.

The operation also includes registering the personalized page and storing the registered personalized page on a central repository before deploying the personalized page. Registering the personalized page also includes naming the personalized page, storing, in the central repository, a deployment region of the personalized page, storing, in the central repository, the one or more components and/or microservices combined on the personalized page, and associating the one or more components and/or microservices combined on the personalized page with the name of the personalized page. The operation also includes monitoring the deployed personalized page for changes and updating central repository when a change occurs. The operation also includes monitoring a deployment region of each personalized page.

In another embodiment, a method for creating a personalized ecosystem includes hosting a plurality of domains. The method also includes registering a plurality of components and/or microservices from the plurality of domains and storing a registry data on a central repository. The method also includes locating the plurality of components and/or microservices from the plurality of domains using the registry data in the central repository and accessing one or more components and/or microservices of the plurality of components and/or microservices from the central repository. The method also includes combining the one or more components and/or microservices on a page to create a personalized page, deploying the personalized page, and duplicating the personalized page to provide to a second user. The duplicate personalized page is deployed and operated by the second user.

### BRIEF DESCRIPTION OF THE DRAWINGS

FIG. 1 illustrates a block diagram of an example system used to produce a personalized page.

FIG. 2 illustrates a flow chart for deploying a personalized page.

FIG. 3 illustrates an example of a processing resource and a non-transitory machine readable storage medium used to create a personalized page.

FIG. 4 illustrates a method for creating a personalized page.

### DETAILED DESCRIPTION

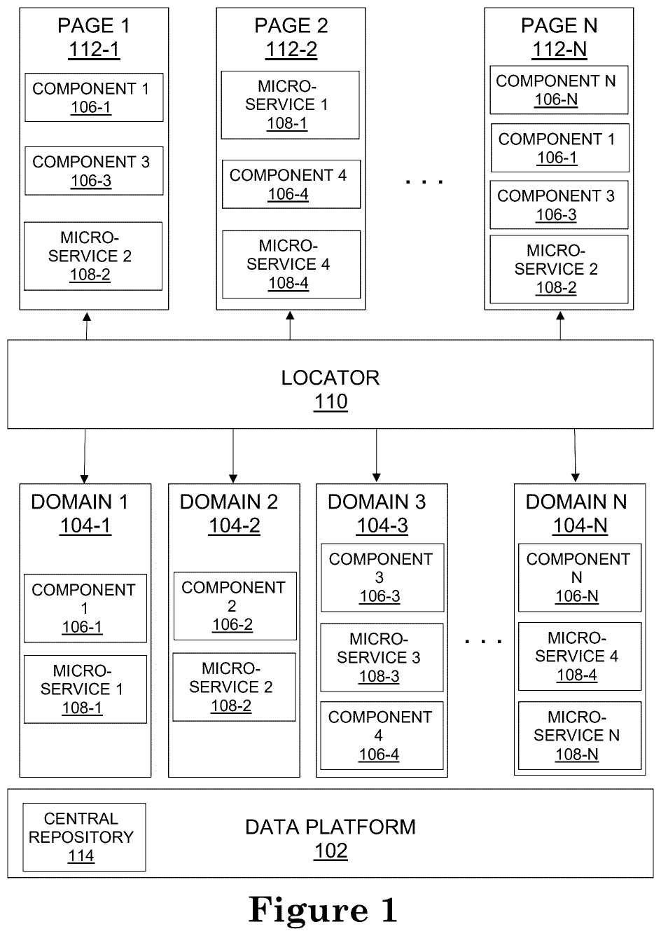

Systems, methods, and apparatuses described herein provide for a rapid development page solution. For example, systems, methods, and apparatuses described herein can includes a central repository that catalogs components, deployments, and configuration information to produce a personalized page, using pre-built components and a solution delivery element to configure the personalized page. The central repository is a single source of information that allows the solution delivery element (e.g., locator 110 of FIG. 1) to use reusable components to deliver personalized pages. Registering components in a central repository, creates a system that provides consistent access to information, which enables the configuration of a personalized page. In addition, registering components to a single repository, stores all components to a single origin creating a secure means of producing personalized page, as compared to obtaining the same information from multiple sources.

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, another, different, etc. may be used herein to describe various elements, these elements should not be limited by these terms. These terms are only used to distinguish one element from another.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting.” depending on the context.

FIG. 1 illustrates a block diagram of an example data platform 102 used to produce a personalized page 112. The data platform 102 can be used to create and deploy a personalized page 112 for a user. As used herein, a personalized page refers to an interactive web application. Page 112 can collectively refer to pages 112-1, 112-2, 112-3, and 112-N. The data platform 102 provides access to different domains 104, which can include servers, databases, networks, etc. Domain 104 can collectively refer to domains 104-1, 104-2, 104-3, and 104-N. The data platform 102 host different components 106 and/or microservices 108 which can be used to create a personalized page 112. A personalized page 112 can include components 106, microservices 108, and/or content from other personalized pages. A component 106 can be web components, web pages (visual components), HTTP APIs, personalized page templates, application, software, etc. As used herein, a data platform refers to a repository and processing house for data used for the collection, cleansing, transformation, and application of data. Component 106 can collectively refer to components 106-1, 106-2. 106-3, and 106-N. Microservice 108 can collectively refer to microservices 108-1, 108-2, 108-3, and 108-N.

The attributes of the component can be registered and stored in a central repository 114 of the data platform 102. As used herein, attributes refer to information which determines the properties of an item (e.g., component, microservices). For example, attributes can include tenancy information, contacts, coding information, description, and processes for common operational activities, etc. Hence, the central repository 114 can catalog a description (e.g., features, uses, visual elements) of the component 106, location of where to access the component 106 (e.g., which domain 104 the component is in), which region the component is deployed in, and which user is hosting the component. As used herein, a domain refers to a collection of interconnected devices and objects, such as computers, servers, networks, users, groups, and/or systems, etc.

In various embodiments, each component can be located in different location (e.g., domains 104, which can include servers, databases, networks, etc.). For instance, as illustrated in FIG. 1 component 1 106-1 is located in domain 1 104-1, component 2 106-2 is located in domain 2 104-2, and component N 106-N is located in domain N 104-N. Conversely, in some embodiments, components 106 can be located at the same location. For instance, as illustrated in FIG. 1 component 3 106-3 and component 4 106-4 are located in domain 3 104-3.

As described herein, the data platform 102 can include microservice 108. As used herein, a microservice refers to an application which includes a collection of services that are independently deployable and loosely coupled. The attributes of the microservice 108 can be registered and stored in a central repository 114 of the data platform 102. Hence, the central repository 114 can catalog a description (e.g., features, uses, visual elements) of the microservice 108, location of where to access the microservice 108 (e.g., which domain 104 the microservice 108 is in), which region the microservices 108 is deployed in, and which user is hosting the microservice 108. Similar to components 106, each microservice 108 can be located in different location or the same location. For instance, similar to the components 106, a domain 104 can host a single microservice 108 or a plurality of microservices 108.

In addition, the content of a personalized page 112 can be registered and stored in a central repository 114. For example, the attributes that make up the personalized page 112 can be registered and stored in a central repository 114 for use in creating another personalized page 112. As such, personalized page 112 can include all of the content of another personalized page 112. In some embodiments, a personalized page 112 can include microservices 108, components 106, content from another personalized page 112, or a combination thereof.

The data platform 102 can include a locator 110. The locator 110 can use the central repository 114 to access components 106, microservice 108, and content of another personalized page 112 to create a personalized page 112. In addition, once a component 106, microservice 108, and/or content of another personalized page 112 is selected, the locator 110 can use the information provided in the central repository 114 to locate the selected options to create the personalized page 112. As used herein, a locator can be a gateway and/or a proxy. In some embodiments, the locator can be a network node used to connect two networks with different transmission protocols together. In some embodiments, the locator can be an intermediary server that accesses/retrieves data from an internet source, such as a webpage, on behalf of another device or user.

In some embodiments, once components 106, microservices 108, and/or content of another personalized page 112 is located, the locator 110 can use the central repository 114 to access each selected option, authenticates the selected options, and obtain authorization to use the selected options before combining the selected options to produce a personalized page 112. For example, the locator 110 accesses the central repository 114 to obtain data including coding information of all the selected options. The coding information is used to combine the coding information of all the selected options to produce a single cohesive application for the personalized page 112. As such, the locator 110 is able to enables runtime composition of the components 106, microservices 108, and/or content of another personalized page 112 to produce a deployable personalized page 112. The locator 110 does not simply copy the separate codes and place them together. The locator 110 is able to facilitate intercomponent communication to combine relevant code information to create a single application including a plurality of different selected options and produce a cohesive personalized page 112.

The locator 110 is able to combine the components 106, microservices 108, and/or content of another personalized page 112 to create a personalized page 112 in a reduced time, compared to a user selecting and combining the components 106, microservices 108, and/or content of another personalized page 112 into a personalized page 112. The data platform 102, as described herein, allows users to rapidly deliver a visually integrated solution (e.g., producing a personalized page 112) that incorporates web components, web pages (visual components), HTTP APIs, personalized page templates, applications, software, and/or microservices, etc. by using a central repository 114 and a locator 110 to locate, characterize, and identify components 106 and microservices 108 in their respective domains 104. Allowing the locator 110 to access and combine components 106, and/or microservices 108 when selected.

For instance, the locator 110 is able to create a personalized page 112 that incorporate content of another personalized page 112, components 106, and/or microservices 108, accessed from respective domains 104. For example, as illustrated in FIG. 1, the locator 110 was able to produce a personalized page 1 112-1 that combined component 1 106-1, component 3 106-3, and microservice 2 108-2, accessed from domain 1 104-1, domain 3 104-3, and domain 2 104-2, respectively. Similarly, the locator 110 was able to produce a personalized page N 112-1 that combined component N 106-N accessed from domain N 104-N and content from personalized page 1 112-1.

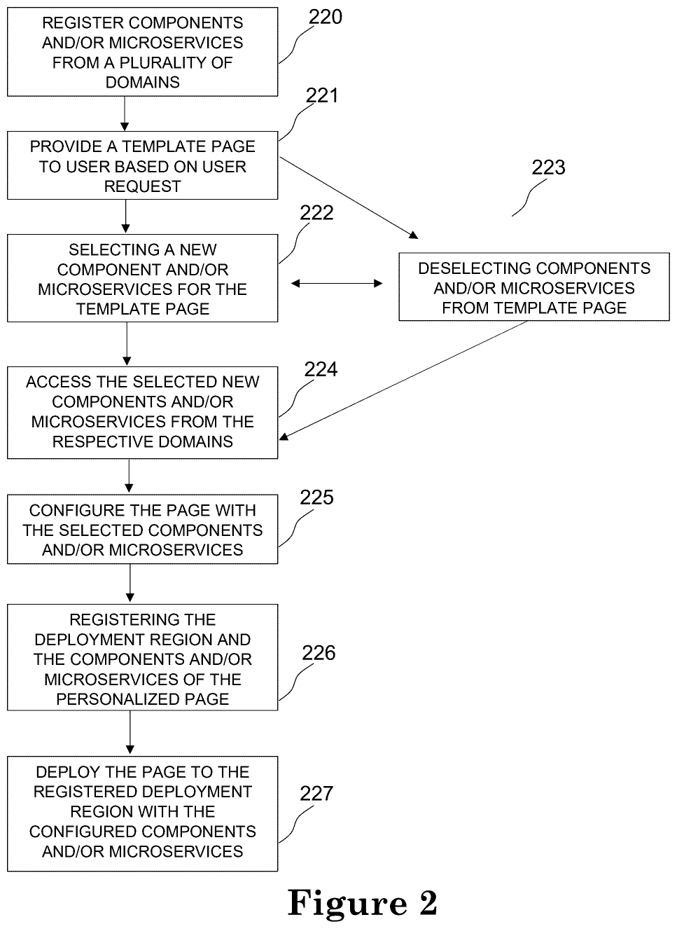

FIG. 2 illustrates a flow diagram 201 for deploying a personalized page. The systems, methods, and apparatuses, described herein allow for independent creation, delivery, deployment, and maintenance of a personalized page using a variety of different domains, which can include servers, databases, networks, etc.

At 220, components and/or microservice are register from a plurality of domains. The systems, methods, and apparatus described herein are able to register and store, in a central repository, information about different components and microservices located on a plurality of different servers, networks, etc. within a plurality of domains. The central repository is a source of information that enables users, via a locator, to leverage components, microservices, and other configurable information to produce a personalized page. The information stored in the central repository provide the necessary data to coordinate and configure a user designed personalized page for deploying without the use of a software development element. The registration process involves collecting information about a web component, web page (visual component), HTTP API, personalized page template, application, software, microservice, etc., reviewing the collected information, and creating and automated processes for combining and deploying a new configuration instance into a personalized page.

At 221, provide a template page to a user based on user request. In some embodiments, the template can have components and microservices already selected. The user is free to remove or keep any pre-selected features of the template page. In various embodiments, the template page can be blank and have no pre-selected features allowing the user to add components and/or microservices, etc. The user can use the template to produce a customized deployable personalized page, by adding and/or removing components and/or microservices, etc. from the template page.

At 222, selecting a new component and/or microservice for the template page. At 223 deselecting components and/or microservice from the template page. A user can shape a template page based on personal preferences. For example, a user can customize the template page by adding and/or removing components, microservices, and or content from another personalized page to/from the template page to create the desired personalized page.

At 224 access the selected new components and/or microservices from the respective domains. To create a personalized page from the template page selected components and/or microservices can be accessed from their location (e.g., domain). A locator can be used to access components, microservices, and/or content from another personalized page to combine them and create the personalized page. The locator uses the information stored in the central repository to determine the location of the selected feature. Once located, the selected feature is then accessed from the respective domain and combined into a customized personalized page.

For example, at 225 configure a personalized page with the selected and/or deselected components and/or microservice. The locator can combine the coding information of the selected options and remove the coding information of the deselected options to configure the personalized page. The locator adjusts and rewrites (e.g., combines) the coding information to produce a cohesive code that brings each component, microservice, and/or content from another personalized page together to form a functional personalized page.

At 226 registering the deployment region and the components and/or microservice of the personalized page. In addition to storing component and microservice information in the central repository, the central repository can store which components and/or microservices are associated with the newly created personalized page. Said differently, the inventory of each personalized page is stored on the central repository. Allowing access, from the central repository, to specific combinations of components and microservices used in different personalized page. The deployment region of the personalized page is also stored in the central repository to ensure the data platform has an accurate account of each deployed personalized pages, as well as the components and microservices used to create the personalized pages. For example, at 227 the personalized page can be deployed to the registered deployment region with the configured components and/or microservice. Once the personalized page is created and the attributes stored in the central repository the personalized page can be deployed to the region designated in the central repository. For example, the combined information can be presented together on a virtual network. As used herein, deploy refers to accessing one or more content (e.g., components, microservices, etc.) from their respective origin location and presenting the one or more content together. In some embodiments, if the user would like to update (e.g., change) the deployment region the central repository will be updated based on the updated deployment region. Similarly, if the components and/or microservices of the personalized page are updated, the central repository will be updated based on the updated components and/or microservices of the personalized page.

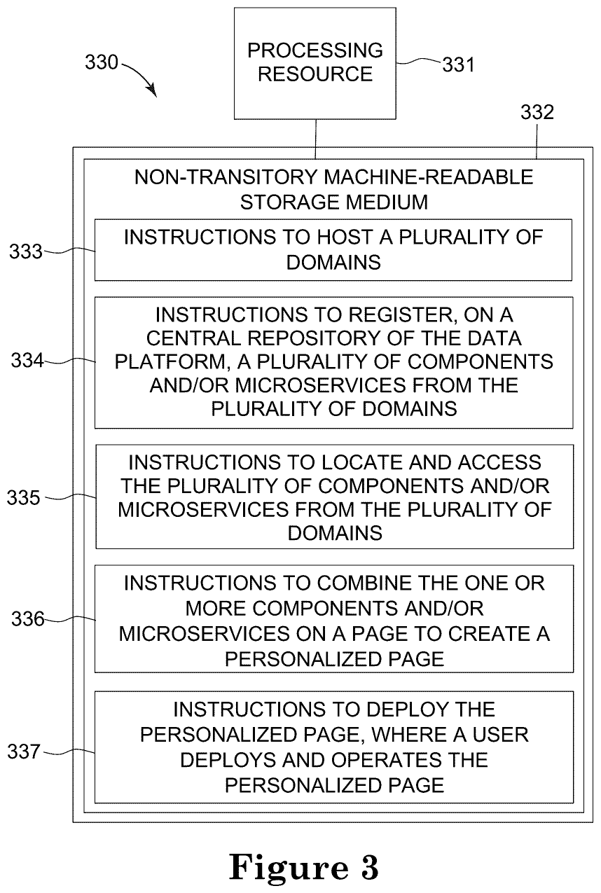

FIG. 3 illustrates an example of a processing resource 331 and a non-transitory machine-readable storage medium 332 used to create a personalized page. A processing resource 331 can be coupled to a non-transitory machine-readable storage medium 332. Although the following descriptions refer to a single processing resource and a single machine-readable storage medium, the descriptions may also apply to a system with multiple processing resources and multiple machine-readable storage mediums. In such examples, the instructions may be distributed across multiple machine-readable storage mediums and the instructions may be distributed across multiple processing resource. Put another way, the instructions may be stored across multiple machine-readable storage mediums and executed across multiple processing resource, such as in a distributed computing environment.

The processing resource 331 may be a hardware processing unit such as a microprocessor, application specific instruction set processor, coprocessor, network processor, application specific integrated circuit (ASIC), general purpose input output (GPIO), or similar hardware circuitry suitable for retrieval and execution of instructions stored in the non-transitory machine-readable storage medium 332. The processing resource 331 may include central processing units (CPUs) among other types of processing units.

In the particular example shown in FIG. 3, processing resource 331 may receive, determine, and send instructions 333, 334, 335, 336, and 337. In another implementation, processing resource 331 may include an electronic circuit comprising a number of electronic components for performing the operations of the instructions in the non-transitory machine-readable storage medium 332. With respect to the executable instruction representations or boxes described and shown herein. it should be understood that part or all of the executable instructions and/or electronic circuits included within one box may be included in a different box shown in the figures or in a different box not shown.

The non-transitory machine-readable storage medium 332 may be any electronic, magnetic, optical, or other physical storage device that stores executable instructions. Thus, non-transitory machine-readable storage medium 332 may be, for example, Random Access Memory (RAM), an Electrically-Erasable Programmable Read-Only Memory (EEPROM), a storage drive, an optical disc, and the like. Non-transitory machine-readable storage medium 332 may be a portable, external or remote storage medium, for example.

Instructions 333, when executed by a processing resources such as processing resources 331, may cause the apparatus 330 to host a plurality of domains. The data platform can host a plurality of components and/or microservices using one or more domains. The domain can include interconnected systems such as networks, servers, databases, etc. In some embodiments, the components and/or microservices can be hosted on the data platform via the interconnected systems of the domain.

Instructions 334, when executed by a processing resources such as processing resources 331, may cause the apparatus 330 to register, on a central repository of the data platform, a plurality of components and/or microservices from the plurality of different domains. Registering components and microservices allows for the components and microservices to be authentication and authorized for use. In addition, registering components and microservices allows the system to identify the attributes of the components and microservices. Identifying the attributes includes isolating the configuration and settings allowing the breakdown and storing of the code information. Said another way, registering components and microservices enables quick configuration of existing and new pages, using the stored code information of the components and/or microservices, as compared to a user configuring the pages using the components and microservices.

Registering components and microservices maps all components and microservices hosted on the data platform to a single origin. Essentially, allowing one or more users to work in an interactive web application independently. Registering, simplifying security concerns and strictly forbidding embedding and cross-origin use. While components and microservices may be from internal and external domains they are all accessed within the same origin preventing cross-origin use.

Instructions 335, when executed by a processing resources such as processing resources 331, may cause the apparatus 330 to locate and access the plurality of components and/or microservices from the plurality of domains. When a component or microservice is registered, the location of the component or microservice is stored in a central repository. A locator can use the stored information to access components and/or microservices from their respective domains. When components and/or microservices are accessed the stored code information is obtained. The locator can then use the stored code information to combine the accessed components and/or microservices to create the personalized page.

Instructions 336, when executed by a processing resources such as processing resources 331, may cause the apparatus 330 to combine the one or more components on a page of the plurality of pages to create a personalized page. Each stored code information of a component or microservice is isolated to prepare the component or microservice to combined with another component or microservice. Isolating the stored code information allows the combining of components and/or microservices in a manner that produces a single code for the personalized page. The combined code of the components and/or microservices can form a single page that can be utilized and deployed.

Instructions 337, when executed by a processing resources such as processing resources 331, may cause the apparatus 330 to deploy the personalized page, where a user deploys and operates the personalized page. A user can deploy the personalized page, on a virtual network hosted on the data platform, for example. However, prior to deploying the personalized page, the deployment region of the personalized page (e.g., location/address), the content of personalized page, the name of the personalized page will be stored in the central repository.

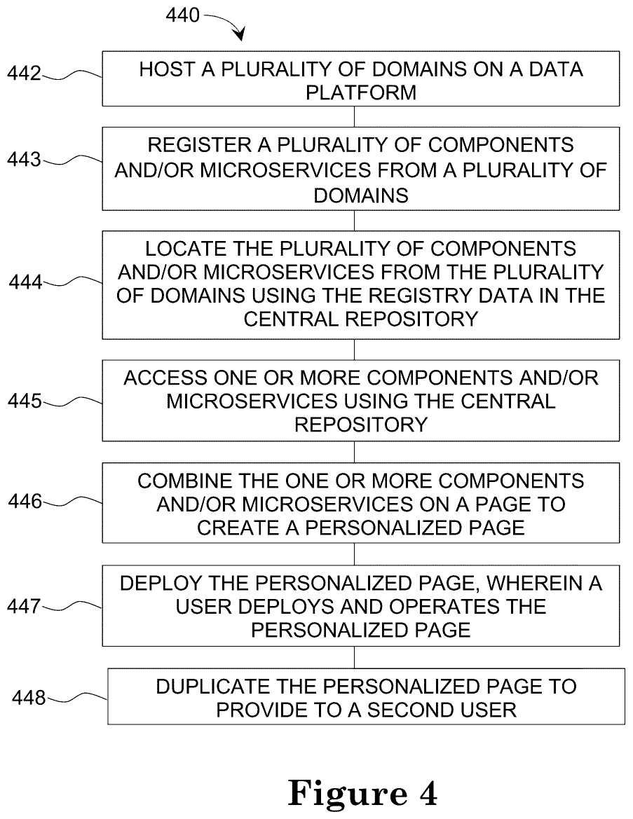

FIG. 4 illustrates a method 440 for creating a personalized page. It is appreciated that a data manager or signal processing engine stored in a memory device may cause a computer processor to execute the various instructions.

At 442 the method 440 includes hosting, a domain on a data platform. The data platform can include a plurality of domains, components, microservices, pages, etc. The domains can include servers, databases, networks, etc. Components and microservices can be hosted on the servers, databases, networks, etc. of the domains. The components and/or microservices can be used to create personalized pages which can be deployed and hosted on the data platform.

At 443 the method 440 includes registering, a plurality of components and/or microservice from a plurality of domains. Components and microservices can be located on domains which can include server, networks, databases, etc. The location and attributes of the components and microservices are stored in the central repository. Allowing the locator to find and use the component and/or microservice when requested. When a component or microservice is registered, it claims its identity for all deployments and solutions. In addition, registering components, microservices, and pages and storing the data in the central repository prevents two items (e.g., registering components, microservices, and pages) existing in different locations being given the same name. In various embodiments, registration allows components, microservices, and pages provided by one user to be available to one or more other users. Registering components, microservices, and pages is a global process that creates a master list of all items and stores relevant operational information, such as its tenancy information, contacts, and processes for common operational activities, etc.

At 444 the method 440 includes locating, the plurality of components and/or microservices from the plurality of domains. At 445 the method 440 includes accessing, one or more components and/or microservice using one or more domains of the plurality of domains. A locator can use the central repository, by obtaining the stored information, to locate and access from their respective domains the selected components and/or microservices selected by a user for a personalized page. At 446 the method 440 includes combining, the one or more components on a page of the plurality of pages to create a personalized page. The locator can then use the accessed components and/or microservices and combine them to create a personalized page ready for deployment. A personalized page ready for deployment can include pages, page sections, page navigation, and visual component interactions. The pages, page sections, page navigation, and visual component interactions are formed based on the information stored in the central repository and the content (components and/or microservice) located at the domain.

At 447 the method 440 includes deploying, the personalized page, where the user deploys and operates the personalized page. Once constructed, the user can select a region to deploy the personalized page. The selected region will be registered and stored in the central repository and the user can deploy the personalized page. The personalized page can be maintained, deployed, and operated by the user. Allowing changes to the personalized page to be made as warranted by the user.

At 448 the method 440 includes duplicating, the personalized page to provide to a second user. In some embodiments, the contents of a personalized page can be stored in the central repository for use by another user. For example, the locator can use some or all of the content of a personalized page to make another personalized page as requested by a second user. The second user can then add additional components and/or microservices as desired. The other personalized page can be deployed by presenting the first personalized page with the added components and/or microservices.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrated and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. An apparatus comprising:
a processing resource;
a memory device storing instructions executable by the processing resources configured to:
host a plurality of domains;
locate a plurality of components and/or microservices from the plurality of domains;
access one or more components and/or microservices of the plurality of components and/or microservices from one or more domains of the plurality of domains;
combine the one or more components and/or microservices on a page to create a personalized page; and
deploy the personalized page, wherein a user deploys and operates the personalized page.

2. The apparatus of claim 1, wherein the plurality of components and/or microservices are software components and/or microservices that are accessed from different domains.

3. The apparatus of claim 1, wherein a plurality of pages are preset with initial components and/or microservices.

4. The apparatus of claim 3, wherein the initial components and/or microservices are removable from the plurality of pages.

5. The apparatus of claim 1, wherein the processing resource is further configured to register the plurality of components and/or microservices from the plurality of domains.

6. The apparatus of claim 5, wherein registering the plurality of components and/or microservices maps the plurality of components and/or microservices to the same origin using a central repository.

7. A system, comprising:
one or more processing resources; and
a memory system including one or more non-transitory, computer-readable storage medium storing instructions that, when executed by at least one of the one or more processing resources cause the system to perform operations, the operations comprising:
registering a plurality of components and/or microservices from a plurality of domains and storing a registry data on a central repository;
locating the plurality of components and/or microservices from the plurality of domains using the registry data;
accessing one or more components and/or microservices of the plurality of components and/or microservices from one or more domains of the plurality of domains;
combining the one or more components and/or microservices on a personalized page; and
deploying the personalized page, wherein a user deploys and operates the personalized page.

8. The system of claim 7, further comprising registering the personalized page and storing the registered personalized page on the central repository before deploying the personalized page, wherein registering the personalized page includes naming the personalized page.

9. The system of claim 8, wherein registering the personalized page includes:
storing a deployment region of the personalized page;
storing the one or more components and/or microservices combined on the personalized page; and
associating the one or more components and/or microservices combined on the personalized page with the name of the personalized page.

10. The system of claim 9, further comprising monitoring the deployed personalized page for changes and updating central repository when a change occurs.

11. The system of claim 7, wherein registering the plurality of components and/or microservices maps the plurality of components and/or microservices to the same origin using the central repository.

12. The system of claim 7, further comprising monitoring a deployment region of each personalized page.

13. The system of claim 7, further comprising duplicating the personalized page to provide to a second user, wherein the duplicate personalized page is deployed an operated by the second user.

14. A method for creating a personalized ecosystem, comprising:
hosting a plurality of domains on a data platform;
registering a plurality of components and/or microservices from the plurality of domains and storing a registry data on a central repository;
locating the plurality of components and/or microservices from the plurality of domains using the registry data in the central repository;
accessing one or more components and/or microservices of the plurality of components and/or microservices from the central repository;
combining the one or more components and/or microservices on a page to create a personalized page;
deploying the personalized page; and
duplicating the personalized page to provide to a second user.

15. The method of claim 14, wherein the plurality of components and/or microservices are software components that are accessed from the plurality of domains.

16. The method of claim 14, further comprising registering the personalized page, wherein registering the personalized page comprises storing, in the central repository:
a deployment region of the personalized page;
the one or more components and/or microservices combined on the personalized page; and
a name of the personalized page.

17. The method of claim 14, wherein the page is preset with initial components and/or microservices.

18. The method of claim 17, wherein the initial components and/or microservices are removable from the page.

19. The method of claim 14, wherein the duplicate personalized page is deployed and operated by the second user.

20. The method of claim 14, wherein registering the plurality of components and/or microservices maps the plurality of components and/or microservices to the same origin using the central repository.
